(19) United States
(12) Patent Application Publication
(10) Pub. No.: US 2023/0245318 A1
(43) Pub. Date: Aug. 3, 2023

(54) INFORMATION PROCESSING DEVICE, CORRECTION METHOD, AND PROGRAM

(71) Applicant: OMRON Corporation, Kyoto-shi, KYOTO (JP)

(72) Inventor: Shinya SAKATA, Kyoto-shi, KYOTO (JP)

(21) Appl. No.: 18/003,414

(22) PCT Filed: Jun. 17, 2021
(86) PCT No.: PCT/JP2021/023103

§ 371 Date: Dec. 27, 2022

(30) Foreign Application Priority Data
Jul. 13, 2020 (JP) 2020-119850

(51) Int. Cl. G06T 7/11; G06V 40/16; G06T 7/136

(52) U.S. Cl. CPC G06T 7/11; G06V 40/161; G06T 7/136; G06T 2207/30201; G06T 2207/10024; G06T 2207/10028; G06T 2207/10048; H04N 23/635

(57) ABSTRACT

An information processing apparatus includes an obtainer that obtains an image and a detection result of an object in the image indicating an area of the object in the image, a determiner that determines a trend value in a first area surrounded by a frame corresponding to the detection result in the image, and a corrector that corrects the frame to define a third area resulting from excluding, from a second area, an area having a difference greater than or equal to a threshold from the trend value. The second area is larger than the first area in the image and includes the first area.

### TECHNICAL FIELD

The present invention relates to an information processing device, a correction method, and a program for correcting a detection result of an object.

### BACKGROUND ART

A known information processing apparatus detects an object included in an image and displays, as a detection result, a detection frame surrounding the object in the image. The information processing apparatus as an imaging device may perform, for example, autofocus on a subject indicated by the surrounding detection frame.

Patent Literature 1 describes a technique for detecting a subject by extracting candidates for a face image portion through spatial frequency filtering on an input image and determining whether the face image portion includes a face based on features.

### PRIOR ART DOCUMENTS

### Patent Document

Patent Literature 1: Japanese Unexamined Patent Application Publication No. 2006-293720

### SUMMARY OF THE INVENTION

### Problems to be Solved by the Invention

However, any detection frame surrounding a face (object) detected with the technique described in Patent Literature 1 may be set either larger or smaller than an image portion in which the face appears. Thus, the detection frame may be placed inappropriately as the detection result of the object.

One or more aspects of the present invention are directed to a technique for appropriately correcting a detection result indicating an object area in an image.

### Means for Solving the Problem

The technique according to one or more aspects of the present invention has the structure described below.

An information processing apparatus according to a first aspect of the present invention includes an obtainer that obtains an image and a detection result of an object in the image indicating an area of the object in the image, a determiner that determines a trend value in a first area surrounded by a frame corresponding to the detection result in the image, and a corrector that corrects the frame to define a third area resulting from excluding, from a second area, an area having a difference greater than or equal to a threshold from the trend value. The second area is larger than the first area in the image and includes the first area.

This structure excludes, from the area larger than the area surrounded by the frame, an area deviating from the trend value in the area surrounded by the frame corresponding to the detection result, and thus can correct the frame to be positioned and sized appropriately. The trend value refers to a representative value indicating the trend in the area.

The corrector may correct the frame to cause the third area to be at a position other than outside the frame and correct the frame to be in contact with the third area. The third area is an area in which the object appears. This structure can thus correct the frame to fit the object. The frame is thus positioned and sized appropriately.

The trend value may be a mode, an average, or a median of pixel values of the first area. This value is used to obtain the trend in the first area appropriately, thus allowing the third area to be determined appropriately and the frame to be corrected appropriately.

The object may be a human face. The information processing apparatus according to one or more embodiments of the present invention may be, for example, an imaging device that appropriately places a frame on a human face using a detection result of the human face and performs autofocus or another operation.

The frame may be rectangular. The corrector may correct the frame to cause sides to be in contact with the third area. The rectangular frame corrected to have its sides in contact with the third area is corrected appropriately to be positioned and sized to fit the area of the object.

The threshold may be based on a difference between a maximum pixel value and a minimum pixel value in the first area or in the second area. This structure can determine the threshold based on the dispersion of pixel values (e.g., differences between background and object pixels) in the first area or in the second area. The frame is corrected to define the appropriate third area based on the dispersion of pixel values (e.g., differences between background and object pixels) in the first area or in the second area.

The image may be a grayscale image or an RGB image. The image may be a range image including pixels each having a pixel value indicating a distance between a subject and an imaging device. The image may be a thermal image including pixels each having a pixel value indicating a temperature of a subject. When, for example, the third area cannot be determined appropriately and the frame cannot be corrected appropriately using a grayscale image or an RGB image including areas with similar colors or close luminance values, the frame can be corrected appropriately using a range image or a thermal image.

The determiner may determine a plurality of trend values different from one another in the first area. The third area may be an area resulting from excluding, from the second area, an area having a difference greater than or equal to a threshold from at least one of the plurality of trend values. The third area can be determined more appropriately using the plurality of trend values, thus allowing the frame to be corrected more appropriately.

One or more aspects of the present invention may be directed to a controller including at least one of the above elements, or to a processing apparatus or a processing system. One or more aspects of the present invention may be directed to a frame correction method or a control method for the information processing apparatus including at least one of the above processes, or to a program for implementing any of these methods or a non-transitory storage medium storing the program. The above elements and processes may be combined with one another in any manner to form one or more aspects of the present invention.

### Effect of the Invention

The technique according to the above aspects of the present invention appropriately corrects a detection result indicating an object area in an image.

### BRIEF DESCRIPTION OF THE DRAWINGS

FIGS. 1A to 1C are diagrams of an image on which a detection frame is set.

FIG. 2 is a block diagram of an information processing apparatus.

FIG. 3 is a flowchart of a process for correcting the detection frame.

FIG. 4A is a diagram describing the setting of the detection frame, FIG. 4B is a diagram describing an object portion, and FIG. 4C is a diagram describing correction of the detection frame.

### MODE FOR CARRYING OUT THE INVENTION

### Application Example

An information processing apparatus 100 according to an embodiment corrects the position and the size of a detection frame (frame indicating an object on an image) as a result of object detection based on a trend value (representative value) in an area surrounded by the detection frame. More specifically, the information processing apparatus 100 obtains the trend value in the area surrounded by the detection frame (an average or a median of pixel values in the area) and corrects the detection frame (detection result) to surround an area (image portion) having a difference less than or equal to a predetermined threshold from the trend value. The trend value herein indicates the trend in the area surrounded by the detection frame and also indicates the trend in the detected object in the image. The detection frame can be corrected to surround the object more appropriately.

### Embodiments

### Structure of Information Processing Apparatus

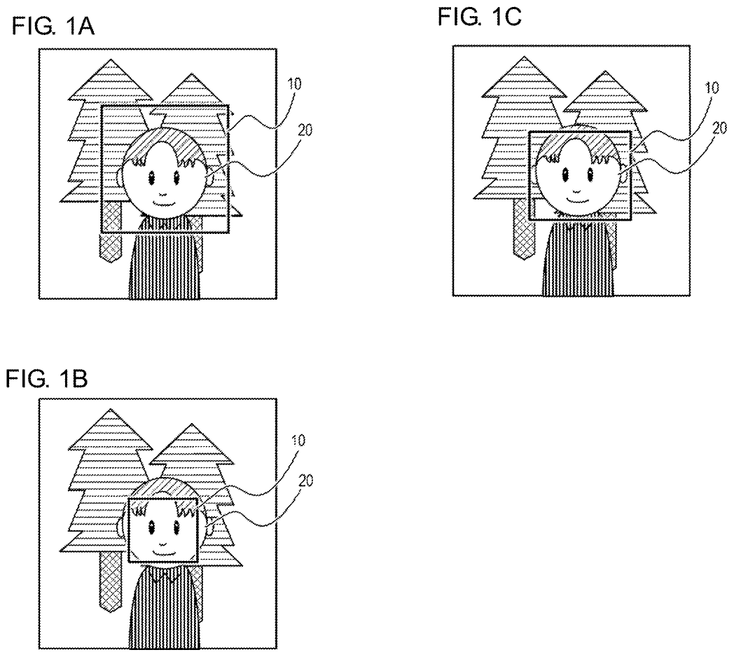

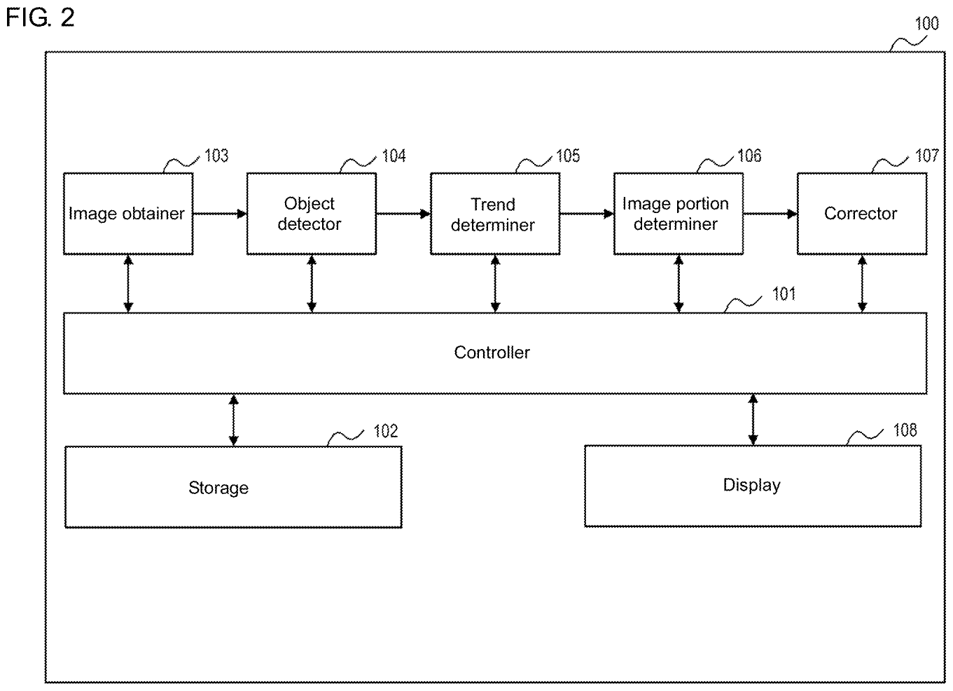

With reference to FIGS. 1A to 1C and 2, the structure of the information processing apparatus 100 according to the present embodiment will be described. FIGS. 1A and 1B each show an image to be processed by the information processing apparatus 100, on which a frame (a detection frame or an object frame) indicating an object is set (superimposed). FIGS. 1A and 1B each show a face 20 of a human as a subject and also a detection frame 10 surrounding the face 20 to indicate the face 20. In FIG. 1A, the detection frame 10 appears larger than an area in which the face 20 appears. In FIG. 1B, the detection frame 10 appears smaller than the area in which the face 20 appears. As shown in FIG. 1C, the information processing apparatus 100 according to the present embodiment thus corrects the detection frame 10 to fit the area in which the face 20 appears (to be sized and positioned appropriately).

FIG. 2 is a block diagram of the information processing apparatus 100. The information processing apparatus 100 is, for example, a personal computer (PC), a smartphone, a tablet terminal, or a digital camera (imaging device). The information processing apparatus 100 may also be a built-in computer such as an onboard computer. The information processing apparatus 100 includes a controller 101, a storage 102, an image obtainer 103, an object detector 104, a trend determiner 105, an image portion determiner 106, a corrector 107, and a display 108.

The controller 101 controls the functional units included in the information processing apparatus 100. The controller 101 is, for example, a central processing unit (CPU). The controller 101 executes a program stored in the storage 102 to control these functional units.

The storage 102 stores, for example, a threshold for determining whether the detection frame is to be corrected and a program executable by the controller 101. The storage 102 may include multiple storage units (recoding units) such as a read-only memory (ROM) for storing a program fundamental to the system, a random-access memory (RAM) for high-speed access to stored (recorded) data, and a hard disk drive (HDD) for storing large volumes of data.

The image obtainer 103 obtains an image in which an object is to be detected. The image obtainer 103 may obtain an image from a source external to the information processing apparatus 100 through an interface or from an imaging unit (not shown) or the storage 102 included in the information processing apparatus 100. The image obtained by the image obtainer 103 may be any image such as an RGB image, a grayscale image, a luminance image, a range image (in which each pixel has a pixel value indicating the distance between a subject (object) and the imaging unit), and a thermal image (in which each pixel has a pixel value indicating the temperature of a subject).

The object detector 104 detects the object included in the image obtained by the image obtainer 103 and sets the detection frame indicating the object as a detection result. The object to be detected herein is a movable object, for example, a human face, an animal, a train, or an airplane. The object to be detected may be preset by a user, or may correspond to a viewpoint position of the user when the viewpoint position (point that the user views in the display 108) is detectable by, for example, a viewpoint detector. The detection frame is rectangular in the present embodiment, but may be in any shape. For example, the detection frame may be circular, elliptical, or polygonal, such as being hexagonal. Setting the detection frame refers to setting information indicating an area of an object as a detection result of the object. In other words, the object detector 104 may set information identifying the detection frame (its position, size, and area), and may set, for example, information about the coordinate positions of four points of the detection frame or about the coordinate position of one point and the vertical and horizontal lengths of the frame as the detection frame.

A method for detecting an object from an image includes, for example, matching between information indicating a prestored object and a part of the image to detect the object based on the degree of similarity obtained through the matching, and the method described in Patent Literature 1. The methods for detecting the object from the image and setting the detection frame may be any known methods, and will not be described in detail. The object detector 104 may not set the detection frame in the image. The image obtainer 103 may obtain an image on which the detection frame is set.

The trend determiner 105 determines a trend value in an area (detection area) surrounded by the detection frame in the image. In the present embodiment, the trend value refers to a representative value (feature) of pixel values in the detection area. The trend determiner 105 determines, for example, the average, mode, or median of the pixel values in the detection area as the trend value.

The image portion determiner 106 searches an area (target area) including the detection area and being larger than the detection area for pixels having a difference less than the threshold from the trend value. The target area may be, for example, twice the detection area vertically and horizontally with its center being at the center of the detection area. The image portion determiner 106 determines, as an image portion including the object (an object portion or an object area), an image portion (area) in the target area containing all pixels having a difference less than the threshold from the trend value. In other words, the object portion is an area (image portion) resulting from excluding, from the target area, pixels (area) having a difference greater than or equal to the threshold from the trend value.

The threshold for determining the object portion herein may be a value input in advance by the user or may be determined by the image portion determiner 106 based on the image. For example, the image portion determiner 106 determines the threshold based on the maximum and minimum pixel values in the detection area, the target area, or the entire image. More specifically, the image portion determiner 106 may determine, as the threshold, a number obtained by dividing the difference between the maximum and minimum pixel values in the detection area or in the target area by a predetermined numerical value (e.g., 5 or 10). The threshold is determined in this manner to allow the threshold to be small when a background and an object are represented by pixel values close to each other and to be large when the background and the object are represented by pixel values greatly differing from each other. Thus, when the background and the object are represented by pixel values close to each other, pixels indicating the background are less likely to be included in the object portion. When the background and the object are represented by pixel values greatly differing from each other, pixels indicating the object are less likely to be excluded from the object portion.

The corrector 107 corrects the detection frame surrounding (indicating) the object portion. In other words, the corrector 107 corrects the detection frame to prevent pixels having a difference, from the trend value, less than the threshold from being external to (outside) the detection frame in the target area. The corrector 107 corrects the detection frame to be in contact with the object portion, allowing the user to substantially match the area of the detection frame with the area in which the object appears.

The display 108 displays an image on which the detection frame corrected by the corrector 107 is superimposed. The display 108 may be an organic electroluminescent (EL) display or a projector.

Some or all of the components shown in FIG. 2 may be formed using an application-specific integrated circuit (ASIC) or a field-programmable gate array (FPGA). In some embodiments, some or all of the components shown in FIG. 2 may be implemented by cloud computing or distributed computing.

[Process for Correcting Detection Frame]

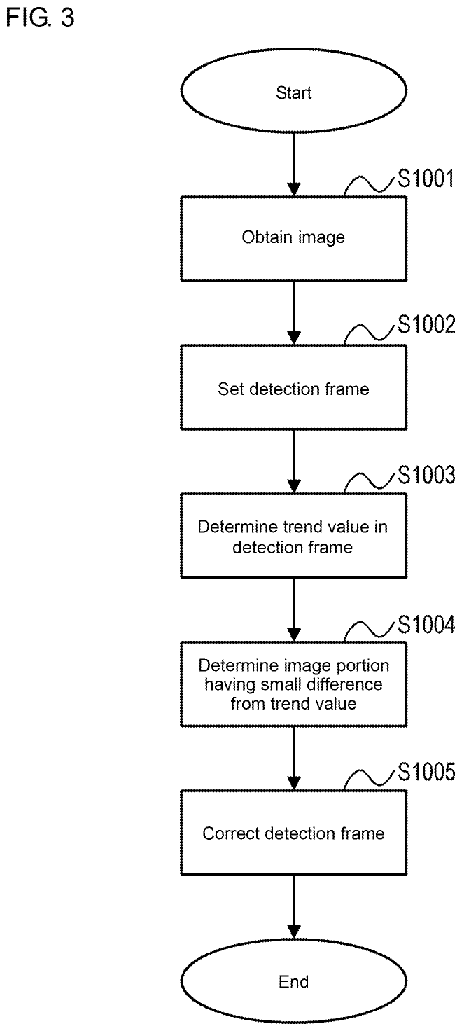

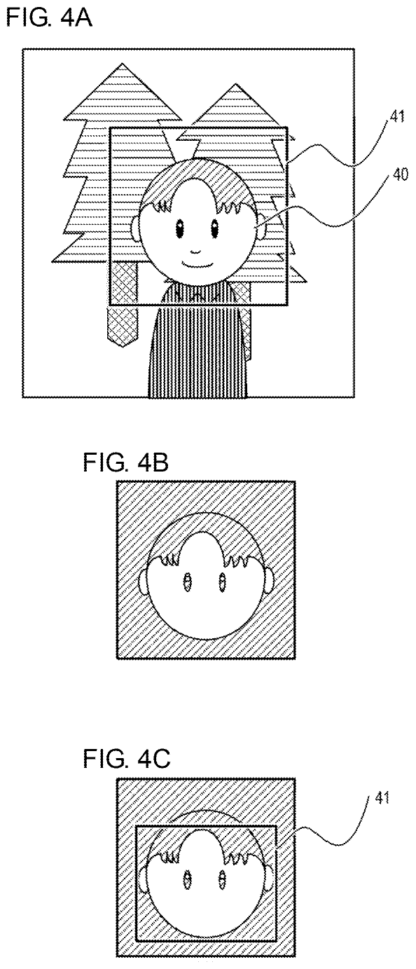

A process for correcting the detection frame (detection frame correction method) in the present embodiment will be described with reference to FIGS. 3 and 4A to 4C. FIG. 3 is a flowchart of the process for correcting the detection frame. The steps in the flowchart in FIG. 3 are performed by the controller 101 executing a program stored in the storage 102 to control the functional units.

In step S1001, the image obtainer 103 obtains an image. The image obtained by the image obtainer 103 may be a live view image obtained by capturing a subject in real time or a video or a still image prestored in the storage 102. The display 108 may display the image obtained by the image obtainer 103.

In step S1002, the object detector 104 detects an object from the image obtained by the image obtainer 103 and sets a detection frame on the image to indicate the object. In the present embodiment, the object to be detected is a human face. For example, the object detector 104 sets a detection frame 41 on an image to indicate a human face 40 as shown in FIG. 4A. Setting a detection frame refers to setting information identifying the detection frame (its position, size, and area) as a detection result as described above.

In step S1003, the trend determiner 105 determines a trend value in the area (detection area) surrounded by the detection frame in the image. As described above, the trend value may be a representative value such as the average, mode, or median of the pixel values of all pixels in the detection area. For the image being a range image or a thermal image, the trend value may be the average, mode, or median of the distance values or the temperature values indicated by all pixels in the detection area. An appropriate trend value may be determined using a range image or a thermal image when, for example, an object and a background have close pixel values but have different distances and temperatures. The detection frame can be corrected appropriately using a range image or a thermal image rather than using an RGB image or a grayscale image when, for example, the face and the background have similar colors.

In step S1004, the image portion determiner 106 determines, in the target area larger than the detection area, an image portion (an object portion or an object area) containing all pixels having a difference less than the threshold from the trend value. In other words, the object portion is an area (image portion) resulting from excluding, from the target area, pixels (area) having a difference greater than or equal to the threshold from the trend value. For example, when the processing in step S1004 is performed in the area surrounded by the detection frame 41 shown in the image in FIG. 4A, a white image portion (not indicated by diagonal lines) shown in FIG. 4B is determined as the object portion. In step S1004, the image portion determiner 106 may determine, as the object portion, an image portion containing blocks (sets of multiple pixels) having a difference less than the threshold from the trend value. In this case, the image portion determiner 106 may determine the object portion based on the difference between the trend value and the average pixel value of each block.

In this case, the target area is larger than the detection area to allow the detection frame to be corrected to be larger when the detection frame set in step S1002 is smaller than the face area. However, when the target area is too large, an incorrect image portion may be determined as the object portion. Thus, the target area may be smaller than the entire image, and may have a size limited to less than or equal to a predetermined times (more than one time) the size of the detection area, such as being less than or equal to two times or to 1.5 times the size (vertical and horizontal lengths) of the detection area. The target area may have a predetermined size to which the size of the detection area is added. The target area may have an average size of the sizes of the detection area and the entire image. Thus, the image portion determiner 106 may determine the target area in an area smaller than the entire image based on the size of the detection area or the sizes of the detection area and the entire image.

After determining the object portion, the information processing apparatus 100 (controller 101) may perform denoising (labeling, magnifying, or reducing) for removing noise from the image obtained in S1001.

In step S1005, the corrector 107 corrects the detection frame (detection result of the object) to surround the object portion. In other words, the corrector 107 corrects the detection frame to have the object portion inside the detection frame. Thus, no pixels (area) with values each having a difference less than the threshold from the trend value are located outside the corrected detection frame in the target area. The corrector 107 may correct the detection frame to have its sides in contact with the object portion. For example, when the image portion not indicated by the diagonal lines in FIG. 4B is the object portion, the detection frame 41 may be corrected in the manner shown in FIG. 4C. The corrector 107 may change the shape of the detection frame in step S1005. For example, the corrector 107 may change the shape of the detection frame from a rectangle to a circle. When the detection frame has a shape other than a rectangle, the corrector 107 may change the shape of the detection frame to a rectangle.

After the processing ends in step S1005, the display 108 may display an image on which the corrected detection frame is set (superimposed). The controller 101 may perform control and autofocus on the area surrounded by the corrected detection frame or may cut, from the area, for example, an image indicating a face and store the image into the storage 102.

The detection frame (detection result) is corrected based on the trend value in the area surrounded by the detection frame and thus is corrected to surround a set of pixels with pixel values close to the trend value. Thus, the detection frame is corrected to indicate a more appropriate area. In some embodiments, the determination may be performed as to whether pixel values are close to the trend value in an area (target area) larger than the area (detection area) surrounded by the detection frame. The detection frame may thus be corrected to be larger, rather than being smaller. The detection frame is corrected appropriately, and thus the information processing apparatus being an imaging device performs, for example, appropriate autofocus on an object appearing in the area surrounded by the detection frame.

### Modifications

In the above embodiment, the information processing apparatus 100 determines the object portion using the single trend value, but may determine the object portion using multiple trend values. A modification differs from the above embodiment in the processing in steps S1003 and S1004 alone in the process for correcting the detection frame shown in FIG. 3, and will be described focusing on the processing in these steps.

In step S1003, the trend determiner 105 determines (obtains) multiple trend values in the area (detection area) indicated by the detection frame in the image. For example, the trend determiner 105 obtains the averages of the R, G, and B values from an RGB image. For an image including, for example, an RGB image and a range image, the trend determiner 105 obtains the average of pixel values of the RGB image and the average of distances indicated by the pixels of the range image.

In step S1004, the image portion determiner 106 determines, in the target area, an image portion (object portion) containing pixels having a difference less than the threshold from the trend values. In other words, the object portion is an area (image portion) resulting from excluding, from the target area, pixels (area) having a difference greater than or equal to the threshold from at least one of the multiple trend values. In step S1003, for example, the trend determiner 105 obtains, as trend values, three values, or specifically the averages of the R, G, and B values. The average is 200 for the R values, 100 for the G values, and 50 for the B values. The threshold is 10. In this case, the image portion determiner 106 determines, in the target area, an image portion containing pixels with the R values of 191 to 209, the G values of 91 to 109, and the B values of 41 to 59 as the object portion.

The structure using such multiple trend values can determine an image portion (object portion) including an object more appropriately and correct the detection frame more appropriately.

The scope of the claims is construed without being limited to the features described in the embodiments described above. The scope of the claims is construed to include the scope understandable by those skilled in the art to solve intended issues in view of the common technical knowledge at the time of filing.

### APPENDIX 1

An information processing apparatus (100), comprising:

an obtainer (103) configured to obtain an image and a detection result of an object in the image, the detection result indicating an area of the object in the image;

a determiner (105) configured to determine a trend value in a first area surrounded by a frame in the image, the frame corresponding to the detection result; and

a corrector (107) configured to correct the frame to define a third area, the third area resulting from excluding, from a second area, an area having a difference greater than or equal to a threshold from the trend value, the second area being larger than the first area in the image and including the first area.

### APPENDIX 2

A correction method, comprising:

(S1001) obtaining an image and a detection result of an object in the image, the detection result indicating an area of the object in the image;

(S1003) determining a trend value in a first area surrounded by a frame in the image, the frame corresponding to the detection result; and

(S1005) correcting the frame to define a third area, the third area resulting from excluding, from a second area, an area having a difference greater than or equal to a threshold from the trend value, the second area being larger than the first area in the image and including the first area.

### DESCRIPTION OF SYMBOLS

100: information processing apparatus, 101: controller, 102: storage, 103: image obtainer,

104: object detector, 105: trend determiner, 106: image portion determiner, 107: corrector,
108: display

1. An information processing apparatus, comprising:
an obtainer configured to obtain an image and a detection result of an object in the image, the detection result indicating an area of the object in the image;
a determiner configured to determine a trend value in a first area surrounded by a frame in the image, the frame corresponding to the detection result; and
a corrector configured to correct the frame to define a third area, the third area resulting from excluding, from a second area, an area having a difference greater than or equal to a threshold from the trend value, the second area being larger than the first area in the image and including the first area.

2. The information processing apparatus according to claim 1, wherein the corrector corrects the frame to cause the third area to be at a position other than outside the frame and corrects the frame to be in contact with the third area.

3. The information processing apparatus according to claim 1, wherein the trend value is a mode, an average, or a median of pixel values of the first area.

4. The information processing apparatus according to claim 1, wherein the object is a human face.

5. The information processing apparatus according to claim 1, wherein
the frame is rectangular, and
the corrector corrects the frame to cause sides to be in contact with the third area.

6. The information processing apparatus according to claim 1, wherein the threshold is based on a difference between a maximum pixel value and a minimum pixel value in the first area or in the second area.

7. The information processing apparatus according to claim 1, wherein the image is a grayscale image or an RGB image.

8. The information processing apparatus according to claim 1, wherein the image is a range image including pixels each having a pixel value indicating a distance between a subject and an imaging device.

9. The information processing apparatus according to claim 1, wherein the image is a thermal image including pixels each having a pixel value indicating a temperature of a subject.

10. The information processing apparatus according to claim 1, wherein
the determiner determines a plurality of trend values different from one another in the first area, and
the third area is an area resulting from excluding, from the second area, an area having a difference greater than or equal to a threshold from at least one of the plurality of trend values.

11. A correction method, comprising:
obtaining an image and a detection result of an object in the image, the detection result indicating an area of the object in the image;
determining a trend value in a first area surrounded by a frame in the image, the frame corresponding to the detection result; and
correcting the frame to define a third area, the third area resulting from excluding, from a second area, an area having a difference greater than or equal to a threshold from the trend value, the second area being larger than the first area in the image and including the first area.

12. A non-transitory computer readable medium storing a program for causing a computer to perform the obtaining, the determining, and the correcting in the correction method according to claim 11.
